(19) United States
(12) Patent Application Publication
(10) Pub. No.: US 2014/0149148 A1
(43) Pub. Date: May 29, 2014

(54) SYSTEM AND METHOD FOR AUTONOMOUS INSURANCE SELECTION

(71) Applicant: Terrance Luciani, Monroe Township, NJ (US)

(72) Inventor: Terrance Luciani, Monroe Township, NJ (US)

(21) Appl. No.: 14/092,618

(22) Filed: Nov. 27, 2013

Related U.S. Application Data
(60) Provisional application No. 61/730,278, filed on Nov. 27, 2012.

(51) Int. Cl. G06Q 40/00

(52) U.S. Cl. CPC G06Q 40/08
USPC 705/4

(57) ABSTRACT

Disclosed herein is a system and a computer implemented method for automatically adjusting a customer's insurance product or insurance portfolio upon a triggering event according to predefined guidelines. For example, a customer's vehicle purchase would cause the system to adjust the customer's auto insurance policy based upon predefined guidelines. Another aspect of the disclosure relates to applying a heuristic approach to create and implement the predefined guidelines.

### CROSS REFERENCE TO RELATED APPLICATION

The present application is a Non-Provisional application of U.S. Provisional Application Ser. No. 61/302,278, filed on Nov. 27, 2012. The contents of that application are incorporated herein by reference.

### BACKGROUND

Insurance products protect customers against various risks. For example, disability insurance can supplement a customer's income when their ability to earn wages is diminished due to illness or injury. Life insurance can protect a customer's family against final expenses and the loss of the customer's financial contributions after the customer has passed away. Home insurance can protect a homeowner against losses due to burglaries and fires.

Shopping for insurance, however, is usually not considered an enjoyable task by customers. Accordingly, many customers prefer to shop for insurance as few times as possible. Even in situations where an event has changed a customer's insurance needs, such as a marriage or birth of a child, customers often will not endeavor to change their insurance products or portfolio due to the inconvenience.

Therefore, there is a need for an effective means of automatically adjusting a customer's insurance product or portfolio in response to events that change the customer's insurance needs. Events that change a customer's needs can include, but are not limited to, marriages, birth of children, new vehicle ownership, new house or apartment ownership, and/or retirement.

### BRIEF DESCRIPTION OF THE DRAWINGS

FIG. 1 illustrates an embodiment providing a customer with automatic insurance portfolio adjustment in response to triggering events.

FIG. 2 describes the process flow in one embodiment of the invention.

### DETAILED DESCRIPTION

Disclosed is a system and computer-based method to automatically adjust a customer's insurance product or portfolio in response to events that change the customer's needs. In a preferred embodiment, the system will use actuarial tables to create a set of data-driven rules for customers. In one embodiment, operation is based on stored records. For example, in this arrangement, actuarial tables and other heuristics are used to determine that customers who have a child require 30% more life insurance benefits. Accordingly, when a customer has a child, the system can automatically raise the customer's life insurance benefits by 30% (and adjust her premiums appropriately).

In another aspect, new insurance products may be added to the customer's insurance portfolio. For example, if a customer purchases their first car, the system may automatically add an auto insurance product to the customer's insurance portfolio with a predefined set of criteria or with criteria that adjust to other current data (DMV records, etc). In a preferred embodiment, the system will have access to actuarial tables and can determine the optimal level of coverage for the customer based on data from other vehicle owners that are similarly situated. In another aspect, when signing up for automatic adjustment of their insurance products or portfolio, as described, the customer can customize their automatic adjustment plan. For example, a customization option may allow for the customer to prioritize “cost efficiency,” the system adjusts the customer's insurance products or portfolios with cost savings (or lower premiums) as the goal; or the customer may choose “best protection” where the system would adjust the customer's insurance products or portfolio with maximum coverage as the goal.

As described above, based on activities, events or milestones reached by customers, the system will change the customer's insurance products or portfolio as needed. Heuristics would be incorporated into the system in a preferred embodiment, and therefore the system would not require customer interaction or approval for updating the customer's insurance portfolio, other than the signing (digital or otherwise) of acceptance of the automatic adjustment product.

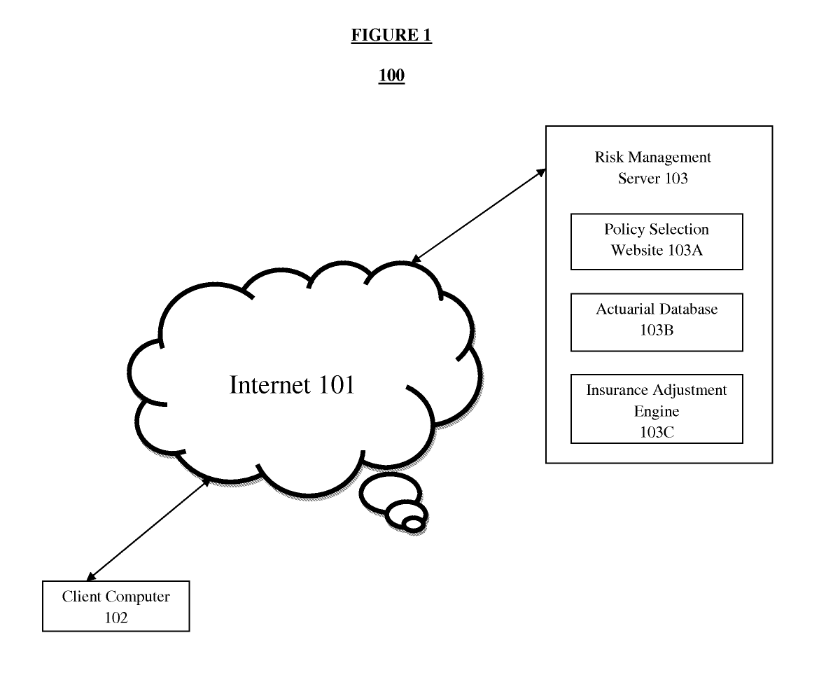

FIG. 1 illustrates an embodiment of the system of the present disclosure for providing a customer with automatic insurance portfolio adjustment in response to triggering events. System 100 includes Client Computer 102 operated by an insurance customer, and Risk Management Server 103 operated by an insurance company. Risk Management Server 103 includes Policy Selection Website 103A for providing a graphical user interface to the customer, Actuarial Database 103B containing insurance related actuarial information, and Insurance Adjustment Engine 103C for adjusting customer insurance products or portfolios. Client Computer 102 is able to access Policy Selection Website 103A via Internet 101. At Policy Selection Website 103A, the customer is able to select the automatic insurance adjustment product or option. The option may be added to a preexisting user account or may be included in a new account. As discussed above, the user may also enter characteristics for the adjustment option (such as cost savings or best coverage).

Additionally, the Policy Selection Website 103A can be used to receive data regarding triggering events. For example, if a user gets married, they may access Policy Selection Website 103A and input the marriage event. Optionally, the Risk Management Server may receive data regarding triggering events from other sources—for example, by scanning public records databases (such DMV records, real-property records, marriage records, etc). After Risk Management Server 103 receives data regarding a triggering event for a customer, Insurance Adjustment Engine 103C adjusts the customer's insurance product or portfolio according to predefined rules and any adjustment characteristics selected by the customer. As discussed above, in one example, the predefined rules are based off of the information contained in Actuarial Database 103C.

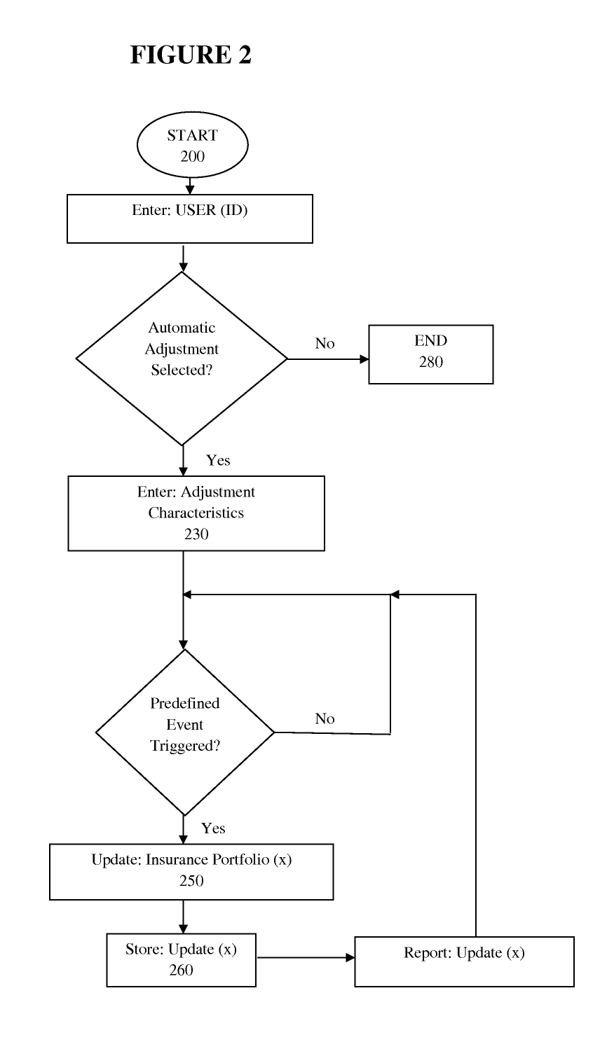

FIG. 2 describes the process flow in one embodiment of the invention. The process starts at step 200, and then continues to step 210 where a user enters her user ID (or name). The system determines if the user has selected the automatic adjustment option, step 220, and if not, the process ends. If the user has selected the automatic adjustment option, the process proceeds to step 230 where the user enters her adjustment characteristics (such as cost savings or best coverage). The process then waits for a predefined event to be triggered, step 240, and if such an event occurs, the system updates the customer's insurance portfolio according to the predefined rules and the user's selected adjustment characteristics, step 250. For example, if the system detects from the DMV registration database that the user has purchased a car, the system will add an auto insurance policy to the user's insurance portfolio (or update the user's existing auto insurance product). The system then reports the update to the customer, for example by sending a letter outlining the new insurance policy terms, and then the system reverts to step 240 waiting for another predefined event.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, smart phones such as iPhones™, tablet devices such as iPads™, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

1. A system to automatically adjust a customer's insurance portfolio in response to life events, comprising:
a data entry receiving port for receiving information entered at a remote communication device, wherein the information includes a customer's selection of automatic policy adjustment criteria;
a selection database for storing the automatic policy adjustment criteria;
a policy database storing a plurality of customer profiles;
at least one data processor programmed to identify events occurring in the customer's life that relate to the customer's automatic policy adjustment criteria; and
at least one data processor programmed to determine adjustments to the customer's insurance policy portfolio based on at least the identified life events and the customer's automatic policy adjustment criteria, and storing the determined adjustments in the policy database.

2. The system of claim 1 wherein the at least one data processor programmed to determine adjustments to the customer's insurance policy portfolio further factors in at least one data-driven rule, wherein the rule is based on at least one actuarial table.

3. The system of claim 1 wherein at least one data processor programmed to identify events occurring in the customer's life monitors social media websites.

4. The system of claim 1 wherein at least one data processor programmed to identify events occurring in the customer's life receives information related to the customer's life events entered on a remote computer.

5. The system of claim 1 wherein the automatic adjustment criteria comprises the customer's selection of insurance policy preferences.

6. A computer-implemented method for automatically adjusting a customer's insurance portfolio in response to life events, comprising:
receiving information entered at a remote communication device, wherein the information includes a customer's selection of automatic policy adjustment criteria;
storing the automatic policy adjustment criteria in a selection database;
identifying events occurring in the customer's life that relate to the customer's automatic policy adjustment criteria; and
determining adjustments to the customer's insurance policy portfolio based on at least the identified life events and the customer's automatic policy adjustment criteria, and storing the determined adjustments in a policy database.

7. The method of claim 6 wherein the adjustments to the customer's insurance policy portfolio are further determined by applying at least one data-driven rule, wherein the rule is based on at least one actuarial table.

8. The method of claim 6 wherein events occurring in the customer's life are identified by monitoring social media websites.

9. The method of claim 6 wherein events occurring in the customer's life are identified from information received from a remote computer that relate to the customer's life events.

10. The method of claim 6 wherein the automatic adjustment criteria comprises the customer's selection of insurance policy preferences.
